(19) United States
(12) Patent Application Publication
(10) Pub. No.: US 2003/0159359 A1
(43) Pub. Date: Aug. 28, 2003

(54) Vehicle door or flap

(76) Inventors: Hans Elsner, Rheinstetten (DE); Karl-Heinz Fueller, Neu-Ulm (DE); Tilman Haug, Weissenhorn (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/339,670

(22) Filed: Jan. 10, 2003

(30) Foreign Application Priority Data
Jan. 10, 2002 (DE) 102 00 516.8

(51) Int. Cl. B60J 5/04

(52) U.S. Cl. 49/502

(57) ABSTRACT

A vehicle door or flap, in particular for motor vehicles, has a frame which is provided as supporting structure. The frame is composed in a modular manner from profile parts or profile blanks and connectors. At least one connector is designed as a fitting, an element for securing a fitting, and/or as an add-on or built-in part of the door.

This application claims the priority of German application 102 00 516.8, filed Jan. 10, 2002, the disclosure of which is expressly incorporated by reference herein.

### BACKGROUND AND SUMMARY OF THE INVENTION

This invention relates to a vehicle door or flap, in particular for motor vehicles, having a frame which is designed as a supporting structure of the door or flap and is separate from an outside and/or inside panel, and fittings which are arranged or can be fitted thereon.

A vehicle door of this type is the subject matter of German publication DE 94 14 798 U1. According to this publication, the doors of a motor vehicle are to have a supporting structure in the form of a U-shaped frame which consists of hollow profiles, preferably assembled hollow profiles, and the U-ends of which are connected to one another by a longitudinal support on the lower window edge of the door. On this frame are to be arranged the door hinges and a unit carrier which is designed, on the one hand, as a supporting part for built-in parts of the door, in particular window-opening units and the like, and, on the other hand, as a securing means for the outside and inside shells of the door.

German publication DE 195 37 504 A1 discloses a vehicle door having a frame which corresponds to the door contour, is designed as a deep-drawn sheet-metal part and is panelled on its outside and inside with outside and inside shell parts. In order to reduce the consequences of an accident in the case of a side impact of the vehicle, the door frame is provided with a side-impact plate which is also used as a carrier of built-in units, in particular window-opening units.

According to German publication DE 198 48 633 A1, in a vehicle door a frame consisting of aluminium profiles is provided. The frame predetermines the contour of the door, is reinforced with a cross member in the region of the lower window edge and is otherwise provided with a door outside wall and a door inside panel. The door inside panel is stiffened by a framework structure and is designed as a unit carrier for built-in parts of the door.

German publication DE 32 39 370 C2 displays the option, in the case of a self-supporting motor-vehicle door assembled from deep-drawn parts, of providing a standardized unit carrier, which serves as the inside part of the door, for securing built-in parts, in particular, of a window-opening unit.

One object of the invention is to reduce the production costs of a vehicle door by standardizing the supporting structure to the greatest possible extent.

The invention achieves this object in a vehicle door or flap by having the frame composed in a modular manner from profile parts or profile blanks and connectors, and by having at least one connector designed as a fitting or means of securing a fitting and/or as a built-in or add-on part.

One general concept of the invention is to provide frames which are identical or are identical with regard to essential modules for extremely different vehicle doors or flaps, and to arrange the add-on or built-in parts of the door or flap directly on the frame. The frame therefore serves both as a supporting structure of the door or flap and as a unit carrier which can be manufactured in advance together with the associated units and fittings without thereby already prejudicing the shape or type of door or flap.

According to a preferred design of the invention, the connectors can be designed as hinges or hinge carriers and/or as a lock socket of the door.

Furthermore, at least some of the connectors, which can optionally also be arranged between two frame parts adjoining each other rectilinearly, and/or as connecting joints between more than two frame parts, can be designed as fastening flanges for built-in parts, in particular window openers, window guides or the like.

Irrespective of the design of the frame, provision can be made to arrange window guides at a variable distance from one another in order to obtain greater freedom when designing the window or the possibility of making different window shapes possible without structural modifications.

With regard to cost-effective production, it is particularly advantageous to produce the connectors by casting in the profile parts or profile blanks. A single casting process is therefore sufficient in order, firstly, to produce the connectors and, secondly, to connect the profile parts or profile blanks forming the frame to one another.

Otherwise, with regard to preferred features of the invention, reference is made to the claims and to the following explanation of the drawings in which a particularly preferred embodiment of the invention will be described in greater detail.

### BRIEF DESCRIPTION OF THE DRAWINGS

FIG. 1 shows a side view of a first embodiment of a door frame, the contour of the door being illustrated by dashed lines,

FIG. 2 shows a perspective illustration of a frame corner, and

FIG. 3 shows an example of a door frame in which, firstly, corner connectors are provided between two frame parts and, secondly, connectors are provided between three frame parts, two of which adjoin each other rectilinearly.

### DETAILED DESCRIPTION OF THE INVENTION

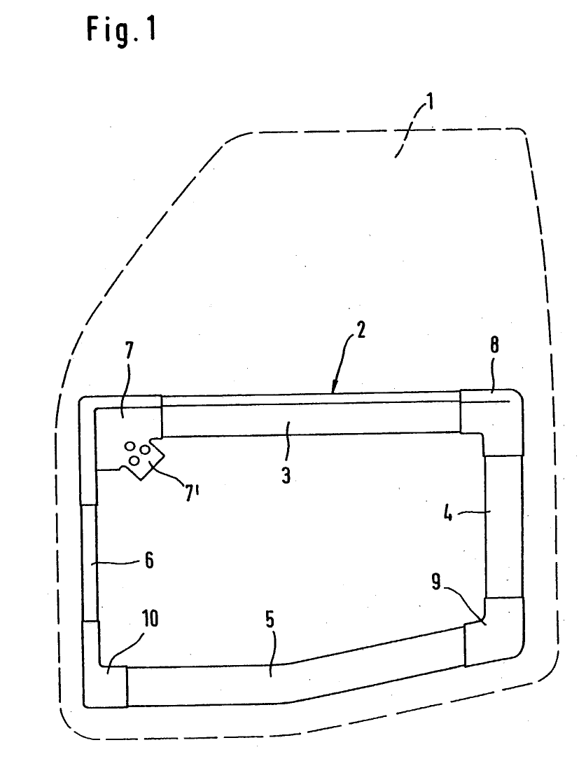

According to FIG. 1, a door 1 of a motor vehicle, only the contour of which door is illustrated by dashed lines, has a frame 2 which is designed as a supporting structure. The frame elements 3 to 6 of the frame are profile parts or profile blanks, in particular extruded profile parts or extruded profile blanks, and are connected fixedly to one another at the frame corners via connectors 7 to 10.

The connectors 7 to 10 are preferably designed as cast parts which can be produced in a particularly expedient manner by the frame elements 3 to 6 being cast in; the frame elements 3 to 6 are fixed or placed into a mould or moulds in such a manner that the connectors 7 to 10 can be produced using a casting technique while simultaneously being fastened to the frame elements 3 to 6.

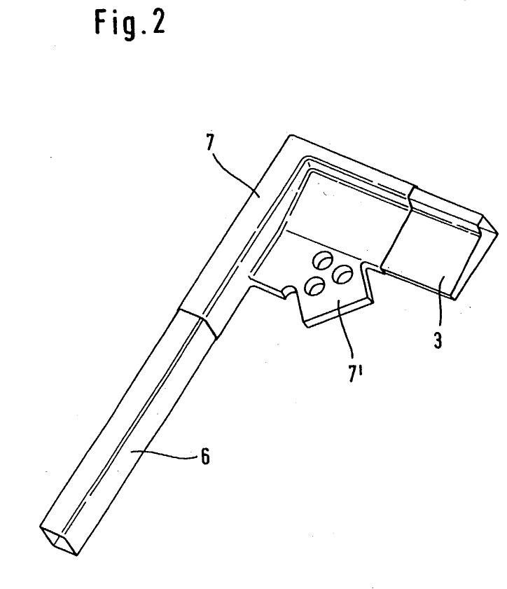

As FIG. 2 shows, the frame elements 3 and 6 can have profile shapes, in particular hollow profile shapes, which differ from one another. In FIG. 2, the frame element 3 is designed as a hollow angled profile while the frame element 6 has a rectangular cross section.

Instead, however, other profiles, in particular open profiles or profiles having open profile channels, are also suitable.

According to the invention, at least some of the connectors 7 to 10 are designed as fitting parts; for example the connector 7 has a flange 7′ which can be used for the fastening of a window-opening motor or the like.

Furthermore, on their edge sides pointing to the left in FIG. 1, the connectors 7 and 10 are provided with holes, which are manufactured or prepared in advance, for receiving fastening elements for hinge parts with which the door 1 can be fitted in an articulated manner to the bodywork (not illustrated) of the vehicle.

Corresponding holes can be provided on the connector 8 for the arrangement of a lock or a lock socket.

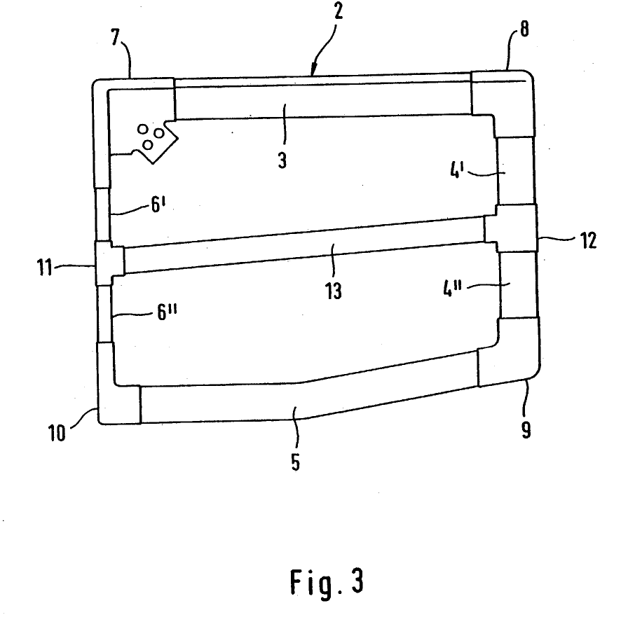

It can be seen from FIG. 3 that the frame 2 may optionally also be subdivided into a plurality of frame zones. In the example of FIG. 3, the vertical frame elements are divided into sections 4′ and 4″ and 6′ and 6″. Further connectors 11 and 12 are arranged between these sections, which connectors are connected to each other by a cross member 13, by means of which the frame 2 is stiffened effectively in a side impact.

In principle, the shape of the frame 2 may differ relatively greatly from the contour of the door 1, since even in the case of very different door shapes, the door hinges and the lock can keep a predetermined position relative to one another. Thus, as a rule, the shape of the frame 2 can remain unchanged.

Nevertheless, it is conceivable that different versions of the frame 2 have to be manufactured in order to be able to take into consideration different door lengths or widths or other door dimensions. In this respect, the invention affords the great advantage that different frame sizes can be produced without substantial modifications to the frame 2. For example, the frame elements 3 and 5 and/or the frame elements 4 and 6 can be cut to different lengths, so that frames 2 of different size can be produced with the production processes and/or the connectors 7 to 12 being able to remain unchanged.

The window guides (not illustrated) which are arranged on the frame 2 are preferably designed in such a manner that their spacings can be changed in order to adapt to different window sizes or shapes.

The connectors 7 to 12 can, inter alia, also be produced by die casting or injection moulding. Production both from metal and from plastic is possible.

Further possible production processes are thixocasting and squeezecasting.

In a departure from the embodiment illustrated in the drawings, provision may also be made to produce the vertical frame elements 4 and/or 6, cf. FIG. 1, and the associated connectors 8 and 9 or 7 and 10 in a casting operation, preferably with the frame elements 3 and 5 being bonded in.

In a corresponding manner, the frame elements 4′ and 4″ and/or 6′ and 6″, cf. FIG. 3, can be produced in a casting operation together with the connectors 8, 9 and 12 or 7, 10 and 11, preferably with the frame elements 3, 5 and 13 being bonded in.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A vehicle door or flap having a frame which is designed as a supporting structure of the door or flap and is separate from an outside panel, an inside panel, or both an outside panel and an inside panel, and fittings which can be arranged or fitted thereon, the frame comprising:
profile parts or profile blanks, and
connectors connecting the profile parts or profile blanks,
wherein at least one of the connectors is designed as at least one of a fitting, means for securing a fitting, and a built-in or add-on part.

2. The vehicle door or flap according to claim 1, wherein the at least one of the connectors is designed as a hinge or a hinge carrier.

3. The vehicle door or flap according to claim 1, wherein the at least one of the connectors is designed as a lock socket or a carrier of a lock socket.

4. The vehicle door or flap according to claim 1, wherein the at least one of the connectors has a fastening flange.

5. The vehicle door or flap according to claim 4, wherein the fastening flange is arranged parallel to the plane of the frame.

6. The vehicle door or flap according to claim 1, wherein the frame is provided with window guides or window-guide carriers.

7. The vehicle door or flap according to claim 6, wherein the window guides or window-guide carriers are parts of said connectors.

8. The vehicle door or flap according to claim 6, wherein the window guides are adjustable.

9. The vehicle door or flap according to claim 1, wherein at least some of the connectors are produced by casting in the profile parts or profile blanks.

10. The vehicle door or flap according to claim 1, wherein at least some of the profile parts or profile blanks are vertical frame elements which are produced together with associated connectors in a casting operation.

11. The vehicle door or flap according to claim 1, wherein the vehicle is a motor vehicle.

12. The vehicle door or flap according to claim. 1, wherein the frame is composed in a modular manner from the profile parts or profile blanks.

13. The vehicle door or flap according to claim 10, wherein at least one of the profile parts or profile blanks is a horizontal frame element which is bonded in.

14. The vehicle door or flap according to claim 2, wherein the at least one of the connectors is designed as a lock socket or a carrier of a lock socket.

15. The vehicle door or flap according to claim 2, wherein the at least one of the connectors has a fastening flange.

16. The vehicle door or flap according to claim 15, wherein the fastening flange is arranged parallel to the plane of the frame.

17. The vehicle door or flap according to claim 3, wherein the at least one of the connectors has a fastening flange.

18. The vehicle door or flap according to claim 17, wherein the fastening flange is arranged parallel to the plane of the frame.

19. The vehicle door or flap according to claim 2, wherein the frame is provided with window guides or window-guide carriers.

20. The vehicle door or flap according to claim 3, wherein the frame is provided with window guides or window-guide carriers.

21. The vehicle door or flap according to claim 4, wherein the frame is provided with window guides or window-guide carriers.

22. The vehicle door or flap according to claim 5, wherein the frame is provided with window guides or window-guide carriers.

23. The vehicle door or flap according to claim 7, wherein the window guides are adjustable.

24. The vehicle door or flap according to claim 2, wherein at least some of the connectors are produced by casting in the profile parts or profile blanks.

25. The vehicle door or flap according to claim 3, wherein at least some of the connectors are produced by casting in the profile parts or profile blanks.

26. The vehicle door or flap according to claim 4, wherein at least some of the connectors are produced by casting in the profile parts or profile blanks.

27. The vehicle door or flap according to claim 5, wherein at least some of the connectors are produced by casting in the profile parts or profile blanks.

28. The vehicle door or flap according to claim 6, wherein at least some of the connectors are produced by casting in the profile parts or profile blanks.

29. The vehicle door or flap according to claim 7, wherein at least some of the connectors are produced by casting in the profile parts or profile blanks.

30. The vehicle door or flap according to claim 8, wherein at least some of the connectors are produced by casting in the profile parts or profile blanks.

31. The vehicle door or flap according to claim 2, wherein at least some of the profile parts or profile blanks are vertical frame elements which are produced together with associated connectors in a casting operation.

32. The vehicle door or flap according to claim 3, wherein at least some of the profile parts or profile blanks are vertical frame elements which are produced together with associated connectors in a casting operation.

33. The vehicle door or flap according to claim 4, wherein at least some of the profile parts or profile blanks are vertical frame elements which are produced together with associated connectors in a casting operation.

34. The vehicle door or flap according to claim 5, wherein at least some of the profile parts or profile blanks are vertical frame elements which are produced together with associated connectors in a casting operation.

35. The vehicle door or flap according to claim 6, wherein at least some of the profile parts or profile blanks are vertical frame elements which are produced together with associated connectors in a casting operation.

36. The vehicle door or flap according to claim 7, wherein at least some of the profile parts or profile blanks are vertical frame elements which are produced together with associated connectors in a casting operation.

37. The vehicle door or flap according to claim 8, wherein at least some of the profile parts or profile blanks are vertical frame elements which are produced together with associated connectors in a casting operation.

38. The vehicle door or flap according to claim 9, wherein at least some of the profile parts or profile blanks are vertical frame elements which are produced together with associated connectors in a casting operation.

39. A method for producing a vehicle door or flap according to claim 1, comprising cutting the profile parts in one of a plurality of different ways used for different door shapes.
